(19) United States
(12) Patent Application Publication
(10) Pub. No.: US 2007/0143825 A1
(43) Pub. Date: Jun. 21, 2007

(54) Apparatus and method of tiered authentication

(76) Inventor: Glen P. Goffin, Dublin, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/313,375

(22) Filed: Dec. 21, 2005

(51) Int. Cl. H04L 9/32

(52) U.S. Cl. 726/2

(57) ABSTRACT

A system and method of authenticating a user is thereby disclosed, comprising providing a plurality of authentication schemes for authenticating a user on a device, each of the plurality of authentication schemes having a varying level of security associated therewith, providing access to a plurality of services to the user through use of the device, each of the plurality of services having a level of information sensitivity associated therewith, associating each of the plurality of services with one of the plurality of authentication schemes, and permitting access of the user to the service associated once a user has properly been authenticated using the corresponding authentication scheme.

### BACKGROUND OF THE DISCLOSURE

1. Field of the Disclosure

The present disclosure relates to authenticating a user. In particular, it relates to a system and method of tiered authentication of a user.

2. General Background

Authentication is the process of determining whether someone or something is, in fact, who or what it is declared to be. Authentication through the use of logon passwords is perhaps the most common method of authenticating a user.

Knowledge of the password is assumed to guarantee that the user is authentic. More accurately, the password provides a “chain of trust”. If a user knows a password, it is assumed by the system that they have been entrusted with it. If the password is stolen, then there must be a break in the chain of command. Each user registers initially (or is registered by someone else), using an assigned or self-declared password. On each subsequent use, the user must know and use the previously declared password. The weakness in this system for transactions that are significant (such as the exchange of money) is that passwords can often be stolen, accidentally revealed, or forgotten.

There are many other different methods of authentication that can be used to authenticate a user. For example, image, voice, fingerprint or other biometric recognition methods are also known methods of authentication. Biometric verification is any means by which a person can be uniquely identified by evaluating one or more distinguishing biological traits. Unique identifiers include fingerprints, hand geometry, earlobe geometry, retina and iris patterns, voice waves, DNA, and signatures. Perhaps the oldest form of biometric verification is fingerprinting.

However, each of such methods of authentication have varying levels of reliability and security. For example, iris-pattern and retina-pattern authentication methods are relatively reliable, and already employed in some bank automatic teller machines. Voice waveform recognition, a method of verification that has been used for many years with tape recordings in telephone wiretaps, is now being used for access to proprietary databanks in research facilities. Facial-recognition technology has been used by law enforcement to pick out individuals in large crowds with considerable reliability. Hand geometry is being used in industry to provide physical access to buildings. Signature comparison is not as reliable, all by itself, as the other biometric verification methods, but offers an extra layer of verification when used in conjunction with one or more other methods.

Each method of authentication has a differing degree of reliability and furthermore, each method of authentication may be employed with varying degrees of ease. Some methods may require greater processing requirements, or sophisticated systems in order to implement. Each method of authentication therefore has a different associated cost.

People currently use their personal computers to access a whole host of services and information. Computers are used to store personal information ranging from contact information including telephone numbers, addresses, and email addresses. Personal computers are commonly used to store and track more sensitive information such as a person's or business's financial records. Banks commonly offer access to accounts online using the Internet. Even further, personal computers are used to collectively store passwords for use at various websites on the Internet.

In many cases, there is no method of authentication used in accessing a personal computer. If there is any method of authentication used, it is through entry of a password. In many cases, entry of the correct password grants the user to access of all information on the computer. In some situations, varying permission levels can be set on a user by user basis, granting users access to a more specific set of information. However, there is still generally one level and one type of authentication used, which access only one subset of the data and services available.

### SUMMARY

A system and method of authenticating a user is disclosed. A plurality of authentication schemes for authenticating a user on a device are provided, each of the plurality of authentication schemes having a varying level of security associated therewith. A plurality of services is further provided to the user through use of the device, each of the plurality of services having a level of information sensitivity associated therewith. Each of the plurality of services is associated with one of the plurality of authentication schemes. Access to a service is permitted to the user once the user has properly been authenticated using the authentication scheme corresponding with the service. The device may for example be a personal computer or a video phone.

In another embodiment, a method of tiered authentication is disclosed having a plurality of services are provided and accessible by a user through use of a device. Each of the plurality of services has a varying permission level associated therewith. Furthermore, a plurality of authentication schemes is provided such that the user may be authenticated and permitted access to at least one of the plurality of services. Each of the plurality of services is categorized with at least one authentication scheme, the level of security of the authentication scheme corresponding to the permission level of the service. The device may for example be a personal computer or a video phone.

Services may, for example, include contact information, financial information, credit card information, passwords, email access, or administrative network permissions/privileges. At least one of the authentication schemes may for example be biometric. Other authentication schemes which may be used include image recognition, fingerprint recognition, voice recognition, or password entry.

In yet another embodiment, a method of tiered authentication is disclosed. A plurality of services which are accessible by a user on a device are provided. The plurality of services are further divided into at least two tiers of services. The at least two tiers of services differ in terms of sensitivity of information. A first level of authentication is provided, the first level of authentication utilizing a first method of authentication to permit access of a user to a first tier of services on the device. A second level of authentication is provided, the second level of authentication utilizing a second method of authentication. The second method of authentication is distinct from the first method of authentication. The second level of authentication is further used to permit access of a user to a second tier of services. The device may for example be a personal computer or a video phone.

### BRIEF DESCRIPTION OF THE DRAWINGS

FIG. 1 is an embodiment of a system in accordance with the present disclosure.

FIG. 2 is a block diagram of an exemplary system of authenticating a user.

FIG. 3 is a block flow diagram of one embodiment of a tiered method for authenticating a user.

FIG. 4 is a block diagram illustrating an exemplary embodiment of tiered services and authentication.

FIG. 5 is a block flow diagram illustrating an exemplary process of providing access to a user of a service in accordance with the present disclosure.

FIG. 6 is a block flow diagram illustrating an exemplary process of providing access to a user of a service in accordance with the present disclosure.

FIG. 7 is a block flow diagram illustrating another exemplary embodiment of tiered services and authentication.

FIG. 8 is a block flow diagram illustrating a further exemplary embodiment of tiered services and authentication.

### DETAILED DESCRIPTION

A system and method of authenticating a user is thereby disclosed, comprising providing a plurality of authentication schemes for authenticating a user on a device, each of the plurality of authentication schemes having a varying level of security associated therewith, providing access to a plurality of services to the user through use of the device, each of the plurality of services having a level of information sensitivity associated therewith, associating each of the plurality of services with one of the plurality of authentication schemes, and permitting access of the user to the service associated once a user has properly been authenticated using the corresponding authentication scheme.

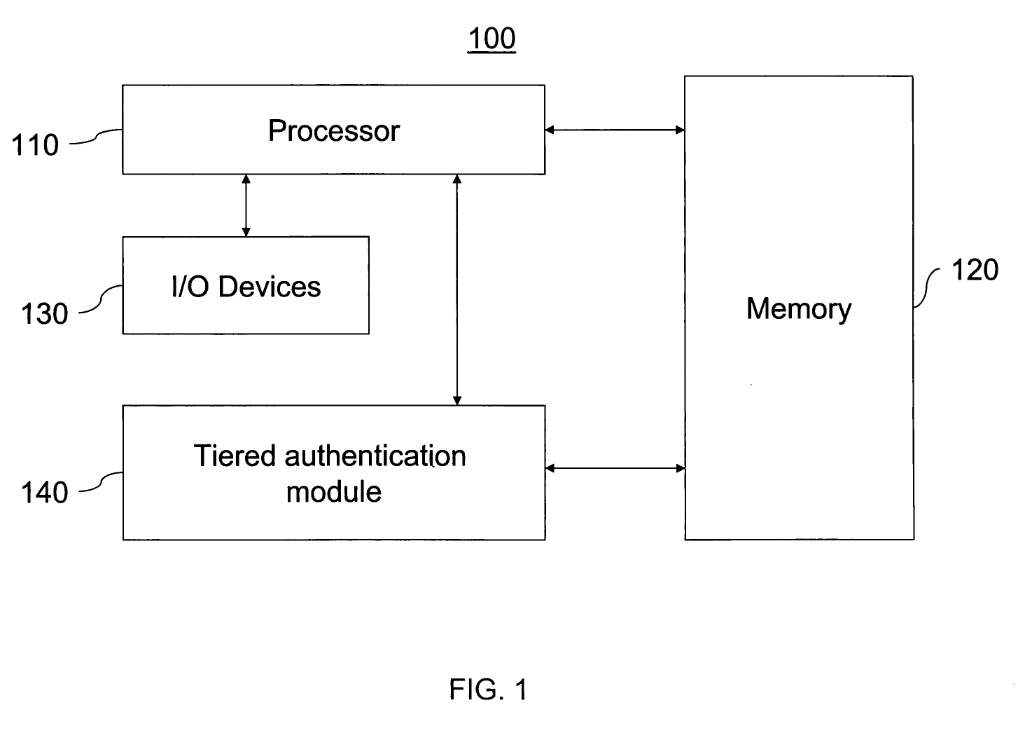

FIG. 1 illustrates a block diagram of a tiered authentication device or system 100 of the present invention. In one embodiment, the tiered authentication device or system 100 is implemented using a general purpose computer or any other hardware equivalents. Thus, image processing device or system 100 comprises a processor (CPU) 110, a memory 120, e.g., random access memory (RAM) and/or read only memory (ROM), tiered authentication module 140, and various input/output devices 130, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the tiered authentication module 140 can be implemented as one or more physical devices that are coupled to the CPU 110 through a communication channel. Alternatively, the tiered authentication module 140 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 120 of the computer. As such, the tiered authentication module 140 (including associated data structures) of the present invention can be stored on a computer readable medium, e.g., RAM memory, magnetic or optical drive or diskette and the like.

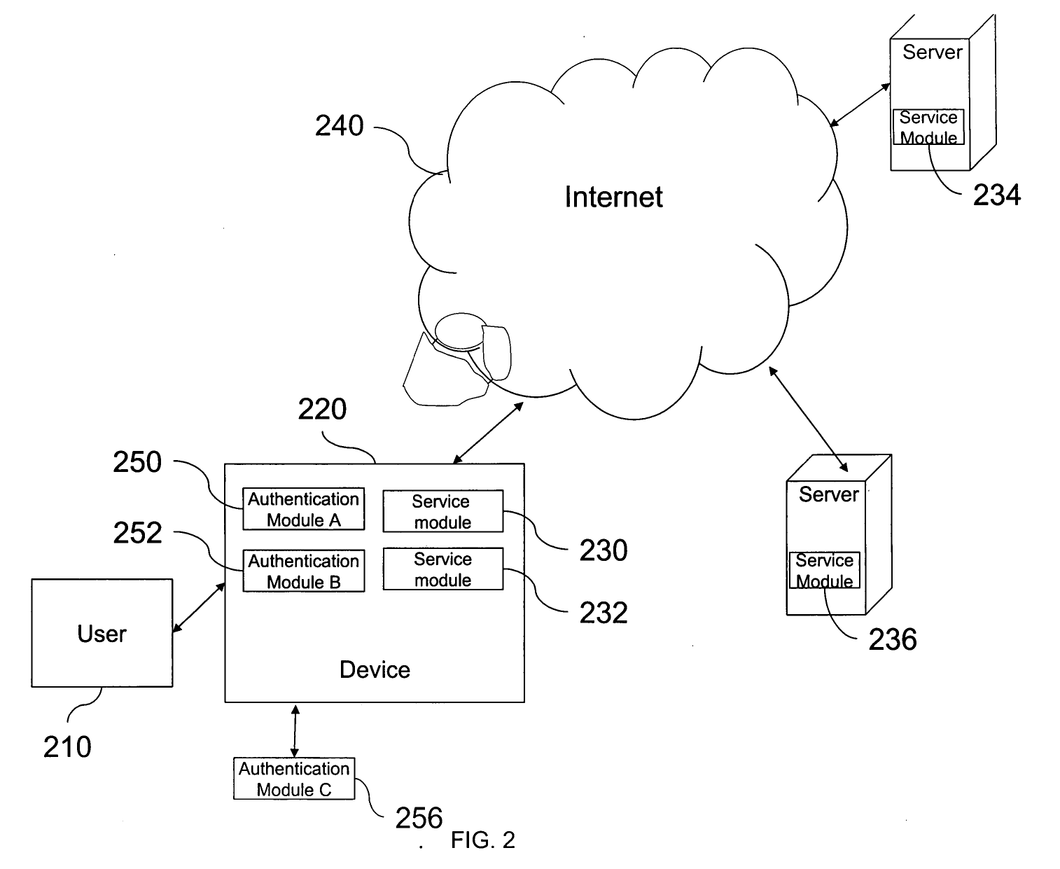

FIG. 2 is a block schematic of an exemplary system and method of tiered authentication in accordance with the present disclosure. The system and method of tiered authentication is used to authenticate a user 210 on a device 220 thereby granting access to one or more services. Device 220 may for example be a computer. In one embodiment, device 220 is a video telephone. Device 220 may be any device offering access to information for which authentication is desired. Alternatively device 220 may for example be a telephone, mobile phone, personal digital assistant (PDA), home media center, set top box, security system, mp3 player, etc.

Device 220 offers user 210 access to a plurality of services. Generally stated, services provide information, privileges, or functions to the user 210. For example, service modules 230 and 232 provide information locally stored on the device 220. Alternatively service modules 234 and 236 may be located remotely and accessible through a communications network such as the Internet 240. Therefore, device 220 may include storage means such as a hard disk drive or flash memory on which information is stored locally, and/or a communications device for communicating through wired or wireless methods with a network such as the Internet. Communications devices for example include ethernet card/adapters, 802.11 cards, modems, Bluetooth, etc.

Examples of service modules 230, 232, 234, and 236 accessible through device 220 may include contact information (names, telephone numbers, email addresses, etc.), buddy lists, personal settings or preferences, email access and/or account information, access to financial accounts, password database, payment information, permissions or privileges for a local area network, web browsing or other internet services, multi-network access, etc.

Each of service modules 230, 232, 234, and 236 are further categorized into at least one of a plurality of tiers. The tiers generally represent different levels of security and are based on the sensitivity of information associated with the service. Any number of tiers may be used, three tiers is used only as an exemplary embodiment for purposes of description.

For example, access to contact information or buddy lists may be considered less restrictive and categorized as a first tier service. Access to payment information or the ability to purchase items, may be categorized in the second tier. Information such as financial information which may include access to personal bank or credit card accounts might be considered in the third tier, as this information is sensitive and

Device 220 offers several methods of authentication 250, 252, and 254 through which a user may be authenticated with the device and be granted access to service modules 230, 232, 234, and/or 236. There is preferably more than one type or method of authentication through which the user can be authenticated. For example, FIG. 2 illustrates an exemplary embodiment wherein three different methods of authentication are employed, as denoted Authentication Module A 252, Authentication Module B 254, and Authentication Module C 256. Authentication modules 250 and 254 are incorporated and implemented within device 220. Alternatively, authentication module 256 is for example implemented separately from but in communication with device 220.

Each different type of authentication method has its strengths and weaknesses. Various factors include expense to implement, processing or system requirements, ease of use, reliability, and strength in security. For example, facial recognition is a method of authentication that may have limited reliability in less robust systems, however provides an extreme ease of use for the user in that little or no input or interaction is required from the user. Other methods, may provide more reliable results and thus provide more security, yet may be more cumbersome for a user to be authenticated through.

Different methods of authentication may for example include biometric recognition methods such as facial, voice, fingerprint, hand geometry, earlobe geometry, retina and iris patterns, DNA, and signatures. Of course other authentication methods such as image recognition and password entry could also be used.

Considering such factors, each method of authentication is categorized, similarly to the tiers of services. Wherein tiers of service are generally categorized in terms of the level of sensitivity of information accessed, authentication methods are generally categorized in terms of level of security. Therefore, each authentication method is categorized as a different level of authentication. As exemplified in FIG. 2, Authentication module A is considered the first level of authentication, Authentication Module B is considered the second level of authentication, and Authentication Module C is considered the third and highest level of authentication.

Even further, each of the levels of authentication is meant to correspond to at least one tier of service. Therefore, the lowest level of authentication permits a user access to the first tier of services, and highest level of authentication permits the user access to the highest tier of services. As the level of desired privacy and sensitivity of information increases, the level of authentication also increases.

An exemplary embodiment of a tiered system and method of authenticating a user is now described. Consider device 220 is a video telephone, perhaps located in a user's home. Videophones typically comprise a camera for capturing images and video of the user during a conversation and display for viewing other callers. Image recognition in conjunction with voice, fingerprint and other methods can be used to provide increasing levels of authentication of a user and increasing permission levels of access to stored information or valuable services. For example, image recognition (probably facial but could utilize other aspects) can be used as a first level of authentication of a user, permitting the user access to a subset of personal information and low value or free services. Additional methods of authentication (such as voice recognition, fingerprint recognition, etc) can be used to permit access to more secure information or higher valued services such as credit card numbers or long distance calling, for example.

Authentication of a user for access to phone information and services is typically done by the user entering a PIN code on a numeric keypad. However, video phones have cameras that can be used to provide a level of authentication. Previous generations of telephones did not utilize continuously active, viewer-facing video cameras and, therefore, did not lend themselves to the use of facial recognition as a user authentication method. Next generation video phones, however, will provide access to many differentiated services and features which will require authentication to access them.

For example, the camera on a video phone can be used as a first level of authentication to perform facial recognition (or recognition of other visual attributes). If recognized, the phone can allow a user to access a subset of information such as phonebooks, buddy lists, call histories, or the like. Facial recognition enables a quick method of authentication, and requires little input from the user. Further methods of authentication such as PIN codes, voice recognition, biometric sensors, key cards, or the like can be used for higher levels of security. This would permit access to higher or subsequent tiers of services, including even more sensitive information, or more valuable services.

In another example, a user approaches the phone and is recognized by the phone using facial recognition, and granted access to a first tier of services, which may include wireline calling (lower rate). However, if the user presses his or her finger against the biometric sensor, a second tier of access is granted, allowing for example use of the cellular network to complete the call (perhaps a more expensive service).

Since IP video phones are often networked devices, the video phone can also act as the authentication console for the home network. In such a case, a second level of authentication could grant administrative rights in the home network, for example.

Even further, the local phone could act as an authentication console and transmit that authentication securely to a remote phone so that a user could gain secure access remotely by dial-up with either the near end or the far end phones performing differing levels of authentication.

In one embodiment, a camera associated with a device can be used to recognize identification (ID) cards, secure logos or other visual credentials. Other credentials could even include images of fingerprints, and the camera could be used as a visual fingerprint ID mechanism. The same could be used for retina scans.

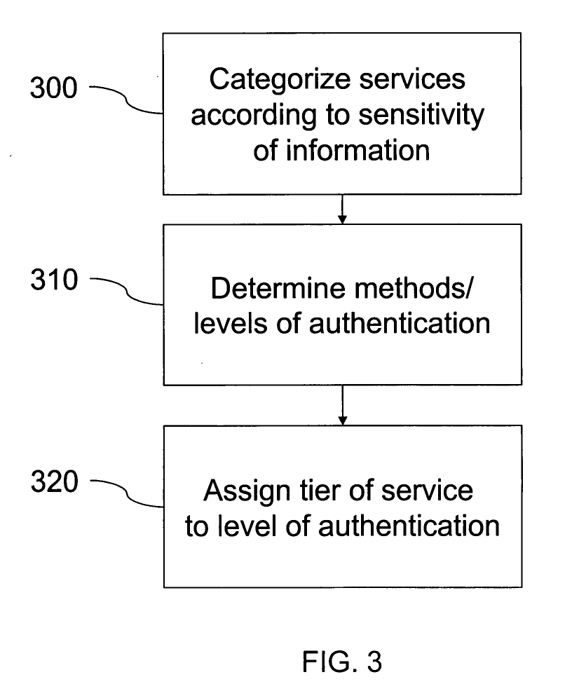

FIG. 3 illustrates a block flow diagram of an exemplary method of tiered authentication, as might be implemented by a service provider, or provider of the device. The method generally involves categorizing services provided into several categories or tiers of information, as indicated at step 300. The categorization is generally done according to the sensitivity of the information associated with the service. At step 310, the different methods of authentication to be used to permit access to each of the categories or tiers of service are determined. Each method of authentication is categorized into different levels of authentication. The categorization is generally done according to the level of security or reliability associated with the method of authentication. Finally, as indicated at step 320, each tier of service is assigned at least one level of authentication through which a user must be authentication in order to permit access to that service.

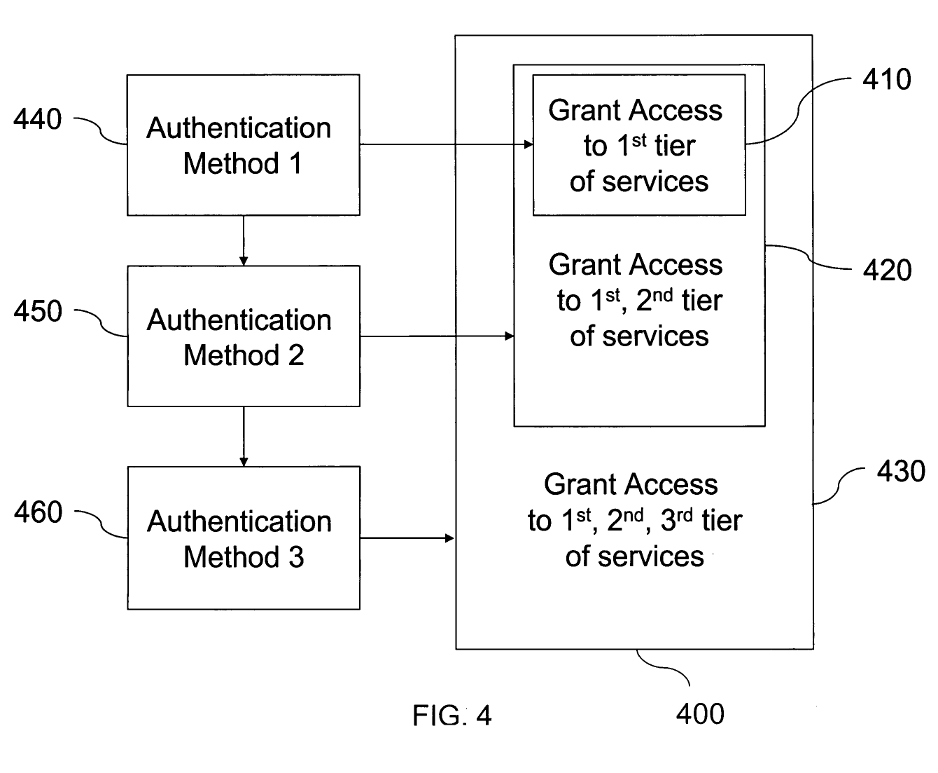

FIG. 4 is another block diagram of an exemplary tiered authentication scheme in accordance with the present disclosure. Services 400 are divided into tiers of service 410, 420, and 430 as has been described thus far, however in this example, the tiers are not necessarily separate or distinct. The embodiment in FIG. 4 illustrates that services 410 are divided in a hierarchical manner. For example, the second tier of service 420 includes the first tier 410 as well, and likewise, the third tier 330 includes the first and second tiers of service 410 and 420 as well.

Therefore, each authentication method may correspond to only one tier of service. Alternatively, each authentication method may correspond to one or more tiers of service. The authentication methods can be used separately, or can be used incrementally, adding levels of security each time a new authentication method is used. For example, in one embodiment the user is authenticated using the second level of authentication 450 in order to gain access to the second tier 420 of services. In another embodiment, the user must first be authenticated using the first level of authentication 440, and then additionally be authenticated using the second level of authentication 450, in order to gain access to the second tier of services 420. It is foreseen that any combination of multiple levels of authentication and tiers of service can be employed.

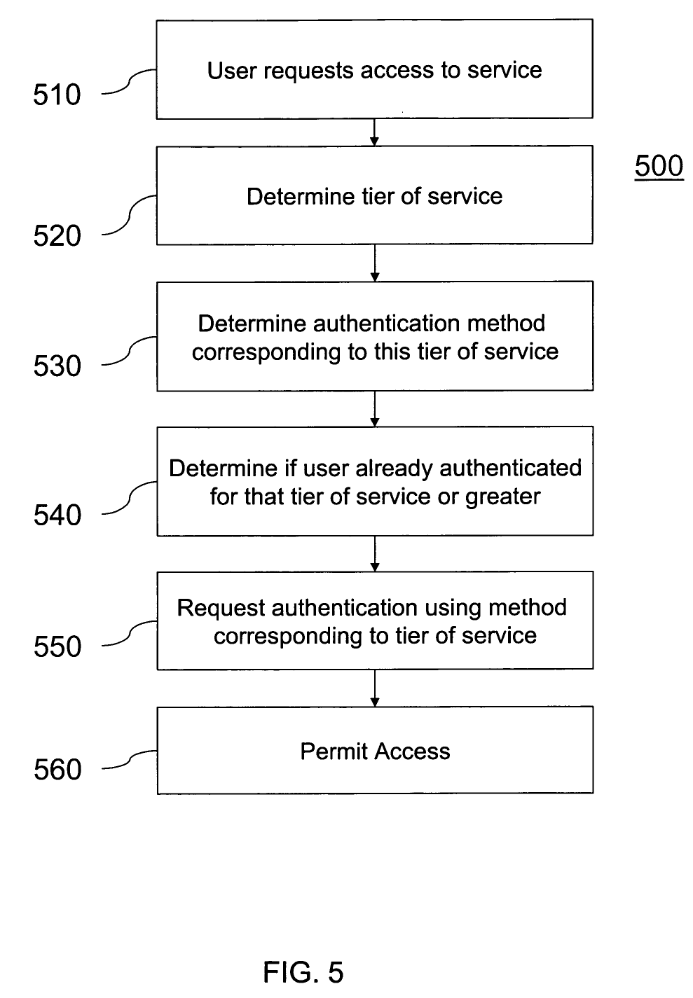

FIG. 5 illustrates a block flow diagram 500 of the logic involved with authenticating a user on a device in accordance with the present disclosure. A user requests access to a service through use of a device, as indicated by step 510. At step 520, the device, or some process associated with the device determines what tier of service the service requested by the user is categorized as. Next, the device determines what authentication method corresponds with granting access to this tier of service, as indicated at step 530. The device then determines whether or not the user is already authenticated for this tier of service as indicated at block 540. The user may already be authenticated for this tier of service, and if so, granted access to the service without any additional authentication. However, if the user is not already authenticated for the tier of service the requested service is categorized as, the user is requested to be authenticated through the corresponding authentication method as indicated at block 550. Once the user has been authenticated, access to the requested service is granted to the user as indicated at block 560.

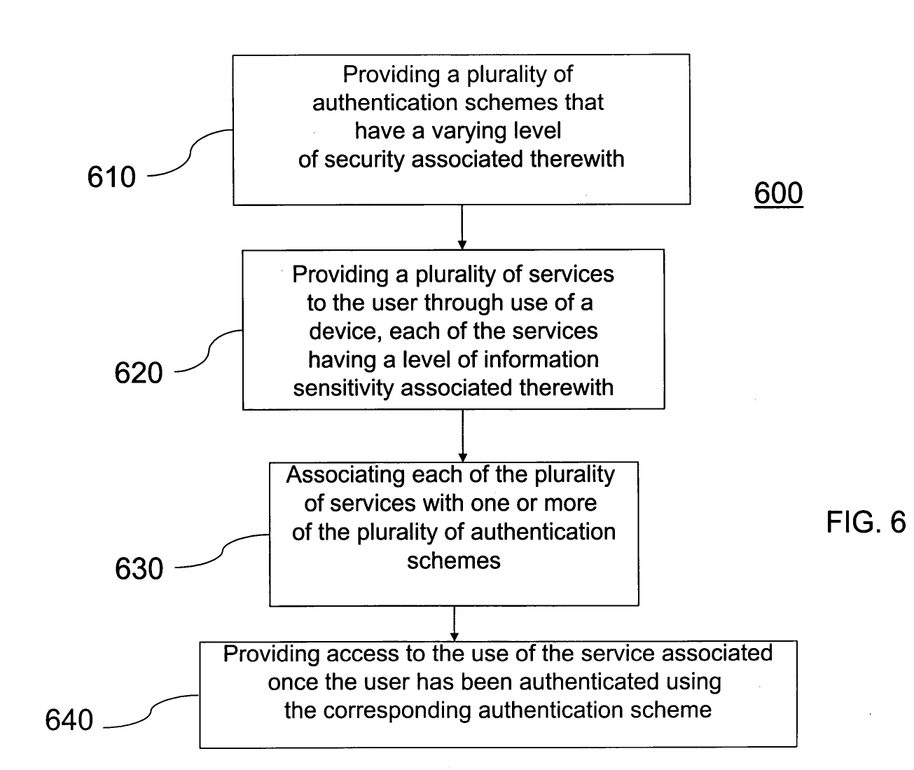

FIG. 6 illustrates a block flow diagram 600 of another embodiment of the logic involved in authenticating a user. At block 610, a plurality authentication schemes is provided for authenticating a user on a device. Each of the plurality of authentication schemes has a varying level of security associated therewith. Furhter, at block 620, a plurality of services is provided to the user through use of the device. Each of the plurality of services having a level of information sensitivity associated therewith. In addition, at block 630, each of the plurality of services is associated with one or more of the plurality of authentication schemes. Finally, at block 640, access is provided to the user of the service associated once a user has properly been authenticated using the corresponding authentication scheme.

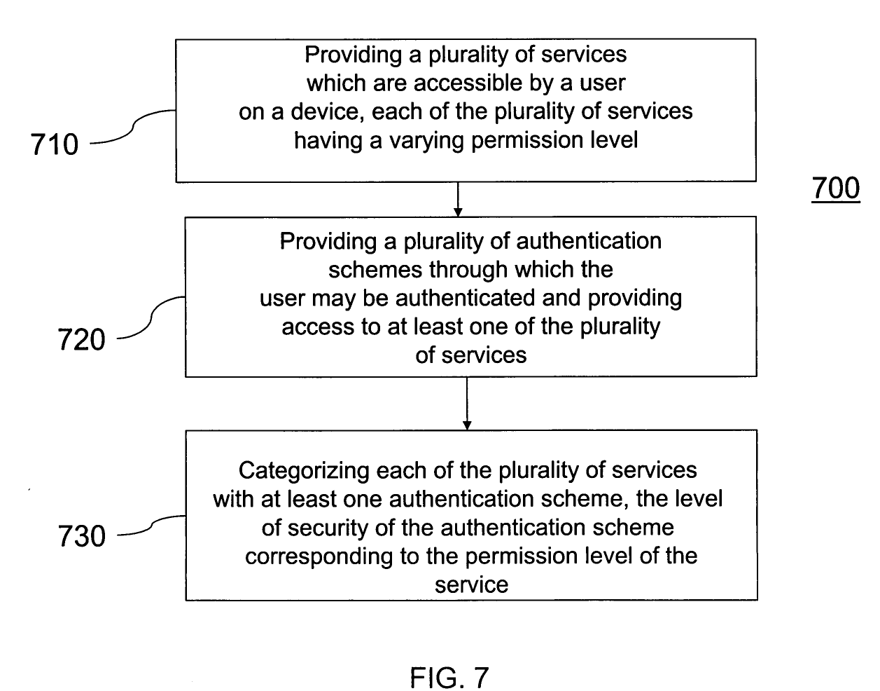

FIG. 7 illustrates a block flow diagram 700 of another embodiment of the logic involved in authenticating a user. At block 710, a plurality of services is provided which are accessible by a user on a device, each of the plurality of services having a varying permission level. Further, at block 720, a plurality of authentication schemes is provided through which the user may be authenticated and provided access to at least one of the plurality of services. Finally, at block 730, each of the plurality of services is categorized with at least one authentication scheme, the level of security of the authentication scheme corresponding to the permission level of the service.

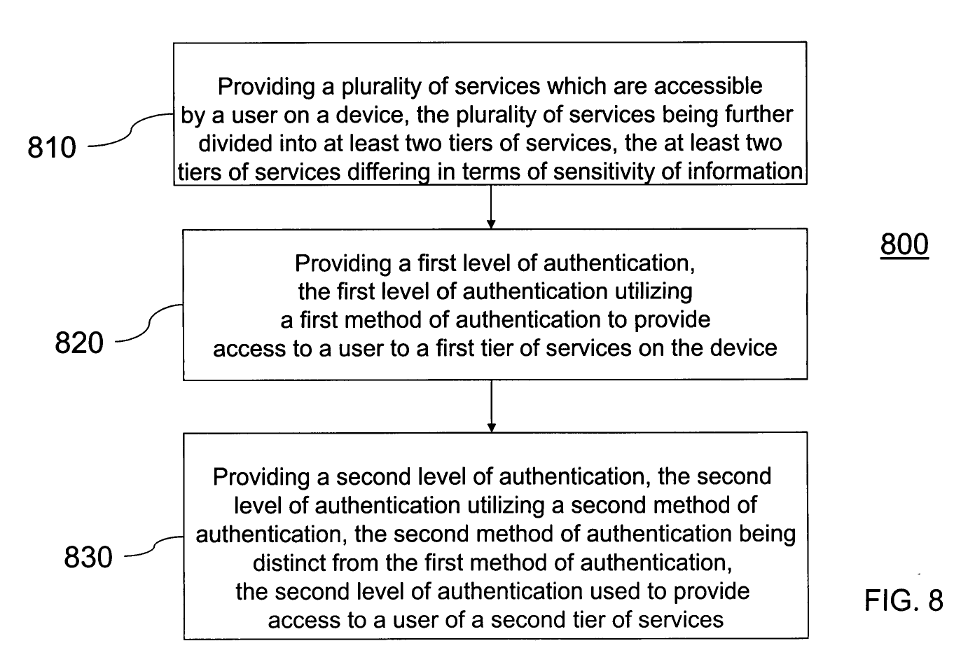

FIG. 8 illustrates a block flow diagram 800 of another embodiment of the logic involved in authenticating a user. At block 810, a plurality of services is provided which are accessible by a user on a device. The plurality of services is further divided into at least two tiers of services. The at least two tiers of services differing in terms of sensitivity of information. Further, at block 820, a first level of authentication is provided. The first level of authentication utilizes a first method of authentication to provide access to a user of a first tier of services on the device. Finally, at block 830, a second level of authentication is provided. The second level of authentication utilizes a second method of authentication. The second method of authentication is distinct from the first method of authentication. In addition, the second level of authentication is used to provide access to a user of a second tier of services.

Although certain illustrative embodiments and methods have been disclosed herein, it will be apparent form the foregoing disclosure to those skilled in the art that variations and modifications of such embodiments and methods may be made without departing from the true spirit and scope of the art disclosed. Many other examples of the art disclosed exist, each differing from others in matters of detail only.

Accordingly, it is intended that the art disclosed shall be limited only to the extent required by the appended claims and the rules and principles of applicable law.

I claim:

1. A method of authenticating a user comprising:
providing a plurality of authentication schemes for authenticating a user on a device, each of the plurality of authentication schemes having a varying level of security associated therewith;
providing a plurality of services to the user through use of the device, each of the plurality of services having a level of information sensitivity associated therewith;
associating each of the plurality of services with one or more of the plurality of authentication schemes; and
providing access to the user of the service associated once a user has properly been authenticated using the corresponding authentication scheme.

2. The method of claim 1 wherein the device is a videophone.

3. The method of claim 1 wherein the device is a personal computer.

4. The method of claim 1 wherein services comprise information.

5. The method of claim 1 wherein services comprise contact information, financial information, credit card information, passwords, email access, or network permissions.

6. The method of claim 1 wherein one of the plurality of authentication schemes is biometric.

7. The method of claim 1 wherein one of the plurality of authentication schemes comprises image recognition, fingerprint recognition, voice recognition, or password entry.

8. A method of tiered authentication comprising:
providing a plurality of services which are accessible by a user on a device, each of the plurality of services having a varying permission level;
providing a plurality of authentication schemes through which the user may be authenticated and providing access to at least one of the plurality of services;
categorizing each of the plurality of services with at least one authentication scheme, the level of security of the authentication scheme corresponding to the permission level of the service.

9. The method of claim 1 wherein the device is a videophone.

10. The method of claim 1 wherein the device is a personal computer.

11. The method of claim 1 wherein services comprise contact information, financial information, credit card information, passwords, email access, or network permissions.

12. The method of claim 1 wherein one of the plurality of authentication schemes is biometric.

13. The method of claim 1 wherein one of the plurality of authentication schemes comprises image recognition, fingerprint recognition, voice identification, or password entry.

14. A method of tiered authentication comprising:
providing a plurality of services which are accessible by a user on a device, the plurality of services being further divided into at least two tiers of services, the at least two tiers of services differing in terms of sensitivity of information;
providing a first level of authentication, the first level of authentication utilizing a first method of authentication to provide access to a user of a first tier of services on the device; and
providing a second level of authentication, the second level of authentication utilizing a second method of authentication, the second method of authentication being distinct from the first method of authentication, the second level of authentication used to provide access to a user of a second tier of services.

15. The method of claim 14 wherein the second level of authentication is used only after the first level of authentication has been granted.

16. The method of claim 14 wherein the second tier of services provides access to information more sensitive than the first tier of services.

17. The method of claim 14 wherein the second tier of services includes the first tier of services.

18. The method of claim 14 wherein the device is a video phone.

19. The method of claim 14 wherein the device is a personal computer.

20. The method of claim 14 wherein the first level of authentication comprises image recognition, and the second level of authentication comprises password entry.
